(19) United States
(12) Patent Application Publication
(10) Pub. No.: US 2006/0059128 A1
(43) Pub. Date: Mar. 16, 2006

(54) Digital content licensing toolbar

(76) Inventors: Matthew J. Ruggle, St. Paul, MN (US); Charles R. Backman, Mankato, MN (US); Adam Bennett, Mankato, MN (US); Corey J. Johnson, Roseville, MN (US)

Correspondence Address: MERCHANT & GOULD PC, P.O. BOX 2903, MINNEAPOLIS, MN, 55402-0903, US

(21) Appl. No.: 10/942,747

(22) Filed: Sep. 16, 2004

(51) Int. Cl. G06F 17/30

(52) U.S. Cl. 707/3

(57) ABSTRACT

A method and apparatus for displaying search results and identifying licensing status for each item in the search result. The invention includes a user menu interface for performing a query on selected criteria and listing results of the query in a specified format. A determination is made as to licensing status for each of the results in the listing an indication is provided with respect to the licensing status for each result in the listing.

### TECHNICAL FIELD

The present invention relates generally to graphical user interfaces for computer systems, and more particularly to a digital content licensing toolbar.

### BACKGROUND

The rapid growth of the Internet and multimedia technology provides a vast distribution of digital content. Such digital content includes text, software programs, graphics, video, and audio in a variety of digital formats. It is technically possible for this digital content to move freely and reside in many locations from the time it is distributed until the time it is finally rendered and viewed by consumers.

One of the most significant issues for digital content providers is illegal use, distribution and re-distribution of the digital content. Typically, a content owner or rights owner, such as an author, a publisher, a broadcaster, etc. (hereinafter “content owner”), wishes to distribute such digital content to a user or recipient in exchange for a license fee or some other consideration. Such content owner would like to restrict what the user can do with such distributed digital content. For example, the content owner would like to restrict the user from making an unlimited number of copies and re-distributing these copies to other users, at least in a manner that denies the content owner a license fee from such other users.

Also, the content owner would like to provide the user with the flexibility to purchase different types of use licenses at different license fees, and at the same time hold the user to the terms of whatever type of license is in fact purchased. For example, the content owner may wish to allow distributed digital content to be copied only a limited number of times.

However, after distribution has occurred, such content owners have very little, if any, control over the digital content. This is especially problematic in view of the fact that practically every new or recent personal computer includes software and hardware necessary to make an exact digital copy of such digital content. Also, the computer can download the exact digital copy to a writeable magnetic or optical disk, or can send such exact digital copy over a network, such as the Internet, to any destination.

Today, content owners are provided with services to protect the distribution of their content. Users who want to copy or reuse content, such as a web page article, can simply click on an icon located on the viewed web page. This icon replaces, for example, the traditional copyright symbol ® and is hyperlinked to an instant clearance service. The article can then be licensed, purchased, and the received article can be used for personal, commercial, nonprofit, or academic reuse, according to the terms and prices set by the content owner. Also, for every license, the service creates a unique alphanumeric identifier stored in a database, which allows the content owner and a reprints provider to track the status of the license. This license also serves as proof of compliance with the content owner's terms of use for both content owner and user.

The service also allows users to request quotes for customized reprints or customized e-prints. The service automatically forwards this request to the content owner's internal or external reprint provider. After receiving the reprints, the users can then distribute the content for their personal needs. Hence, simple and quick reuse of original content is legally obtained by providing instant access to rights and permissions at a point of acquisition of the content.

Further, the service is beneficial to content owners because it presents the content owners' various licensing options, processes the payments, issues the licenses, and fulfills the content in the form specified by the user. The service also ensures that the brand and intellectual property rights of the content owners are protected and monetized. Further, it allows an extension of their brand name and opens new revenue streams.

However, the service includes much inefficiency. For example, drawbacks to the service include wasting time filling out lengthy permission request forms when logging into multiple password protected sites and determining the licensability of numerous articles.

### SUMMARY

In general terms, the present invention is a digital content licensing toolbar for providing search capabilities and notice of licensable subject matter.

One aspect of the present invention is a method for displaying search results and identifying licensing status, including performing a query on a selected criteria, listing results of the query in a specified format, and indicating a licensing status for each result in the listing.

Another aspect of the present invention is directed to a computer system for displaying search results and identifying licensing status for each item in the search results, the computer system including a user interface, a processor coupled to the user interface for displaying a toolbar on the user interface, the toolbar having a search field for performing a search on a selected criteria, an output device coupled to the processor for listing results of the search in a specified format, and an indicator linked to each search result in the listing for displaying a licensing status for each of the results in the listing.

Another aspect of the present invention is directed to a user menu interface for identifying licensing status for each item in a search result, including a search field for performing a search on selected criteria, and an indicator displaying the licensing status for a selected result in the listing.

Another aspect of the present invention is a program storage device readable by a computer tangibly embodying one or more programs of instructions executable by the computer to perform a method for displaying search results and identifying licensing status, the method including performing a query on a selected criteria, listing results of the query in a specified format, and indicating a licensing status for each result in the listing.

Yet another aspect of the present invention is directed to a system for associating tagged content with a licensee, the system including one or more content owners providing tagged content, and a user menu interface associated with a specific licensee for displaying license status of tagged content, wherein the license status displayed is based on the tagged content of the one or more content owners for which the specified licensee has purchased a license.

### DESCRIPTION OF THE DRAWINGS

FIG. 1 is a block diagram illustrating one possible embodiment of a system implementing a digital content licensing toolbar according to the present invention;

FIG. 2 illustrates one possible embodiment of a computer system that includes the functional blocks of FIG. 1;

FIG. 3 is a block diagram illustrating an installation procedure for the digital content licensing toolbar according to the present invention;

FIG. 4 is a functional diagram illustrating the general functionality of the digital content licensing toolbar according to the present invention;

FIG. 5 illustrates one possible embodiment of a graphics user interface (GUI) application including a digital content license toolbar according to the present invention;

FIG. 6 illustrates a general setup functionality for the digital content license toolbar according to the present invention;

FIG. 7 illustrates the search functionality of the digital content license toolbar according to the present invention;

FIG. 8 illustrates a search results summary report generated by the digital content licensing toolbar;

FIG. 9A illustrates a content provider functionality of digital content licensing toolbar according to the present invention; and

FIG. 9B illustrates additional content provider functionality of digital content licensing toolbar according to the present invention.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

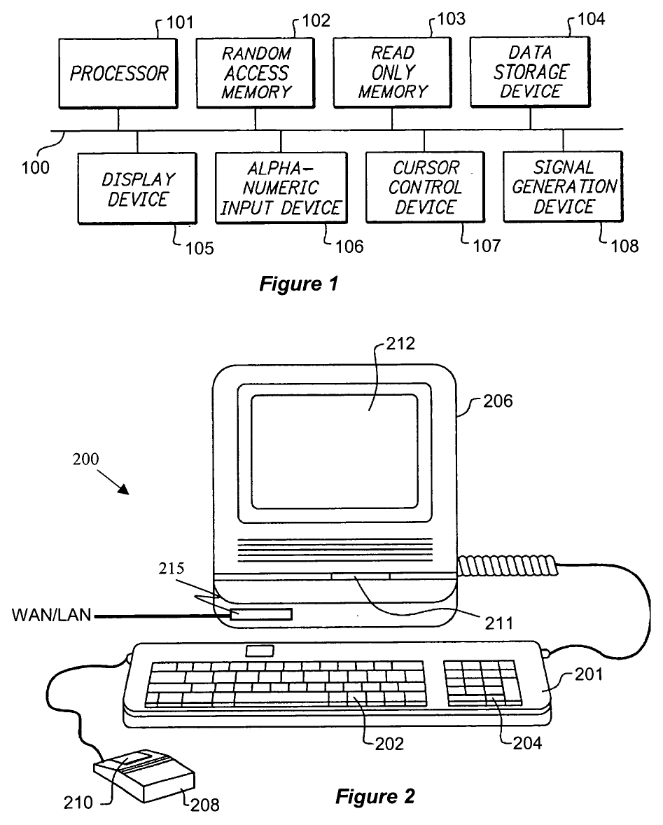

FIG. 1 is a block diagram illustrating one possible embodiment of a system implementing a digital content licensing toolbar. A user menu interface, such as a toolbar, can be any device or mechanism that is displayed on a user interface, such as a graphical user interface, which permits a user to trigger functions or commands used in an applications in an expedited manner. It will be readily appreciated by those skilled in the art that user interfaces and elements of user interfaces may be used in combination with any system having typical system components such as, for example, a processor and a display. It should further be noted that the present invention may be embodied as an article of manufacture such as a software disk, optical disk, software download from a network, or the like including instructions for causing a processor to carry out steps in accordance therewith.

In general, such computer systems, as illustrated in block diagram form in FIG. 1, may include, for example, bus 100 for communicating information, processor 101 coupled with bus 100 for processing information and instructions. The system also includes random access memory 102 coupled with bus 100 for storing information and instructions for processor 101, read only memory 103 coupled with bus 100 for storing static information and instructions for processor 101, data storage device 104 which may be, for example, a magnetic disk and disk drive or CD-ROM/DVD-ROM drive, coupled with bus 100, also for storing information and instructions.

The data storage device 104 stores an operating system for controlling the operation of the programmable computing system. It will be appreciated that this component may comprise a general-purpose server operating system such as UNIX, LINUX™, or Microsoft WINDOWS. A basic input/output system (“BIOS”) is also provided for controlling low-level operation of the computing system.

Display device 105 can be coupled to bus 100 for displaying information and providing visual feedback to a computer user. It will be understood that display device 105 can include appropriate interfaces such as a graphics adapter or the like. Alphanumeric input device 106 may further be coupled to bus 100, and may include, for example, a keyboard including alphanumeric and function keys for communicating information and command selections to processor 101. Cursor control device 107 may be coupled to bus 100, and, through visual feedback on display device 105 from, for example, a pointer icon associated with a mouse, may communicate information and command selections to processor 101. Signal generating device 108 can further be coupled to the bus 100 for providing signal related input/output functions to processor 101.

Display device 105 can preferably be, for example, a liquid crystal device, cathode ray tube, or other display device suitable for creating images and alphanumeric characters including ideographic character sets recognizable to the user. Cursor control device 107 may allow the computer user to control the two-dimensional movement of a visible symbol such as a cursor and/or a pointer on a display screen of display device 105.

Many implementations of cursor control device 107 are known in the art including a trackball, mouse, joystick or special keys on the alphanumeric input device 106, any of which may be capable of signaling movement of a given direction or manner of displacement of a corresponding visual indication such as a pointer icon, or visual representation of a cursor. It is to be appreciated that the cursor may be directed and/or activated via input from alphanumeric input device 106, such as a keyboard, using special keys and key sequence commands.

Alternatively, a cursor may be directed and/or activated via input from a number of specially adapted cursor directing devices; including those uniquely developed for the disabled. For example, a cursor may be directed and corresponding adjustments in the position of a cursor and/or corresponding selections, activations, and the like as might be seen, for example, by operating a mouse button may be made through devices specifically adapted to recognize speech input. In the discussions regarding cursor movement and/or activation within the possible embodiments, it is to be assumed that the input cursor-directing device or push button may consist of any of those described above and specifically is not limited to a mouse cursor device.

FIG. 2 illustrates one possible embodiment of computer system 200 that includes the functional blocks of FIG. 1. It will be appreciated that such a computer system is one of many computer systems that may be used in accordance with the present invention. Accordingly, keyboard 201 having, for example, keys 202 and numeric keypad 204 may be attached to computer 206 along with a cursor control device such as, for example, mouse device 208 having one or more mouse push buttons 210 for providing and controlling certain relocation and activation features associated with the cursor and, for example, an iconographic object which it may be “pointing” to. Mouse device 208 and push buttons 210, for example, may make up one example of a device in accordance with cursor control device 107 (FIG. 1). It will be appreciated that many other devices may be used as cursor control device 107, for instance, keyboard 201 may be substituted for mouse device 208 and buttons 210 as described. Computer 206 also typically contains one or more media drives 211, which may include, for example, a floppy disk, hard disk or CD ROM. Computer 206 may include a display screen 212, which as described may include, for example, a CRT, LCD display, and the like.

In some applications, computing system 200 acts as a World Wide Web (web) server to transmit web pages to a web browser application program executing on requesting devices to carry out this process. For instance, a web server may transmit pages used for retrieving information from a user. In one embodiment, the form elicits such information as user preferences, address, telephone number, billing information, credit card numbers, and the like. Moreover, the web server can transmit web pages to a requesting device and allow a user to interact with web pages. The interaction can take place over the Internet, WAN/LAN, or any other suitable communications network.

The computing system 200 is connected to a WAN/LAN, or other communications network, via network interface unit 215. Hence, it will be appreciated that the network interface unit 215 includes the necessary circuitry for connecting computing system 200 to the WAN/LAN, and is constructed for use with various communication protocols including the TCP/IP protocol. Typically, the network interface unit 215 is a card contained within the computing system 200.

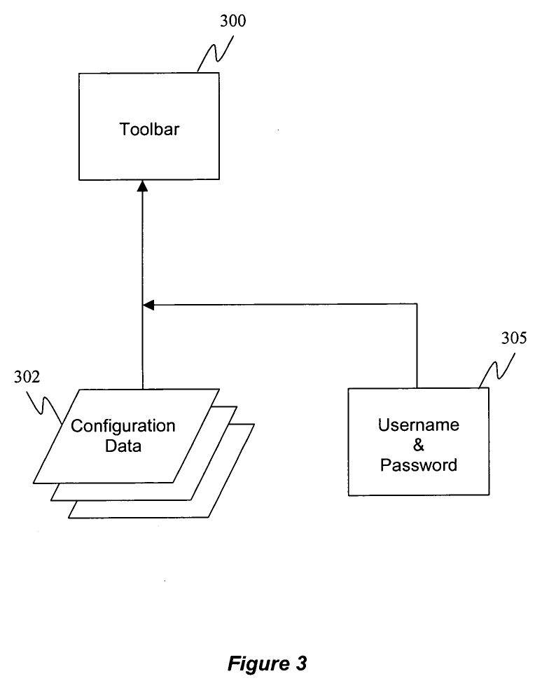

FIG. 3 is a block diagram illustrating an installation procedure for the digital content licensing toolbar 300. The digital content licensing toolbar 300 provides various menu items (or icons) such as adding, moving, invoking, and removing the toolbar 300 to or from an operating system or the like. The menu items provide familiar toolbar-like features across applications and window instances within an operating system user interface environment such as, for example, Microsoft WINDOWS operating system and other operating systems that provide a user interface.

The digital content licensing toolbar 300 can be associated with a variety of applications, such as an Internet browser, e.g., INTERNET EXPLORER. However, the installation is not limited to this application and the digital content licensing toolbar 300 can be installed in any suitable software environment. The digital content licensing toolbar 300 is downloaded, for example, via a signed cabinet (CAB) files 302 located on a distribution diskette or from the Internet. When prompted, for example, a username and password 305 is entered to allow the user to download the toolbar 300.

Standard data, such as extensible markup language (XML) data, is stored in the CAB files 302 as well as on the Internet. Extensible markup language is a markup language for documents containing structured information. The structured information contains both content for the toolbar 300 (words, pictures, etc.) and some indication of what role that content plays. For example, the extensible markup language data downloaded from the Internet will provide dynamic configuration data that can change the look of the toolbar 300 without forcing a user to acquire a new version.

When installing the toolbar 300 via the Internet, a complete install package can be downloaded from the provider's (or the toolbar 300) site. The install package will prompt the user for valid information such as the user's company name and department. The install process will also validate various key codes to ensure that user has valid site licenses for the sites the user plans to visit; a site license being a license authorizing one or more persons employed by a single enterprise to utilize materials protected by copyright and/or trademarks belonging to others. For example, key code can provide access to a variety of company sites, such as ADWEEK, REUTERS and WIRELESS REVIEW.

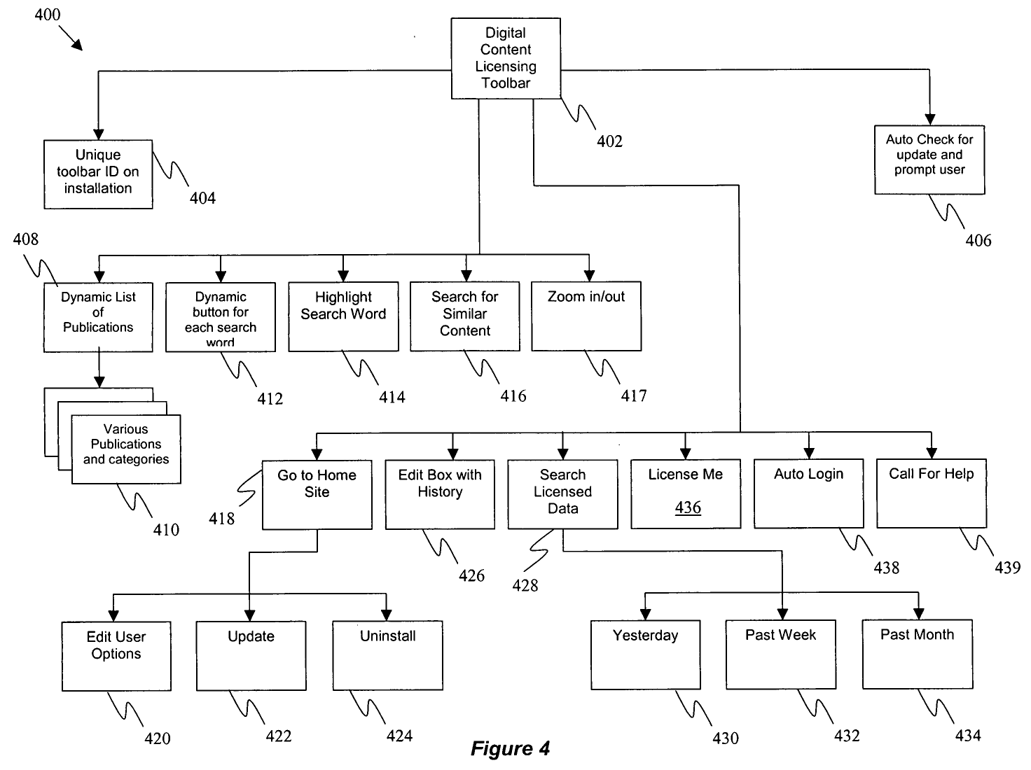

FIG. 4 is a functional diagram 400 illustrating the general functionality of the digital content licensing toolbar 402. The following is a brief explanation of the functionality of several of the possible toolbar menu items. The digital content toolbar 402 provides, but is not limited to, this functionality. However, a more detailed description of selected and additional functionality will be discussed later. The toolbar need not contain each of these functional elements but may be customized based upon the user company or individual user specifications.

Upon installation of the toolbar 402, as discussed in FIG. 3, a unique toolbar identifier 404 is provided. The identifier allows software to uniquely identify a user when an associated browser is activated. This identifier can be used to track user acquired licenses by the content owner or reprint provider. An auto check update 406 is provided and prompts the user when updates to the toolbar are available. The user has the option to accept or cancel the update operation.

When text is entered into a search field on the toolbar 402 and a query is executed and a list of publications 408 is generated. The list contains an abstract for each of the publications. Also, each publication abstract in the list is provided with a link, such as a hyperlink, to the actual article (i.e., content) or category of articles 410. A dynamic button icon for each search word 412 provides the user with a link to the next occurrence of the queried word on the current page (or other pages) of the currently viewed article. The highlight search word functionality 414 allows the user to see each occurrence of the queried word highlighted in a publication. The queried word can be highlighted in, but is not limited to, any font, color or texture provided by the application. Furthermore, when an article is selected, the user can use the search for similar content icon 416 to generate a list of similar subject matter. Zoom in/out functionality 417 allows the user to view, for example, a web page in greater or lesser detail.

Other functionality provided by the digital content licensing toolbar 402 includes allowing a user to go to the home site 418. The home site functionality 418 includes menu items such as editing user options 420 (e.g., username and password), executing updates 422, and an uninstall 424 function to allow removal of the toolbar 402. More specifically, the edit user options menu item 420 stores user account information. When the user selects the edit user options menu item 420, the user profile within the provider's website is displayed. The user can now edit a variety of options, such as the user's account profile, email notifications, billing information, etc.

Two levels are provided for the user's account profile. The first level is an individual user profile that contains information such as the username, password and personal information such as company name, address, age, gender etc. The second level is an administrative account profile. The administrative account profile stores account profile information such as billing information for the company.

The edit box with history functionality 426 maintains the history of the queried text string. This history can be used to recount prior searches. A “searched licensed data” functionality 428 allows the user to gather content from different time periods, such as yesterday 430, the past week 432, and the past month 434. The user can then choose the license functionality 436 to purchase or license the content.

Auto login functionality 438 allows the user to bypass the sign-in process by transparently signing-in the user by using information from the user's account. Hence, the user can view a selected page from an otherwise password-protected site without the burden of filling out lengthy request forms or logging-in.

Finally, a call for help functionality 439 allows the user to request additional information about content that the user is viewing. The user's information, along with a link to the content the user is viewing, can be sent to a customer service representative of the content provider who can investigate the inquiry and respond accordingly.

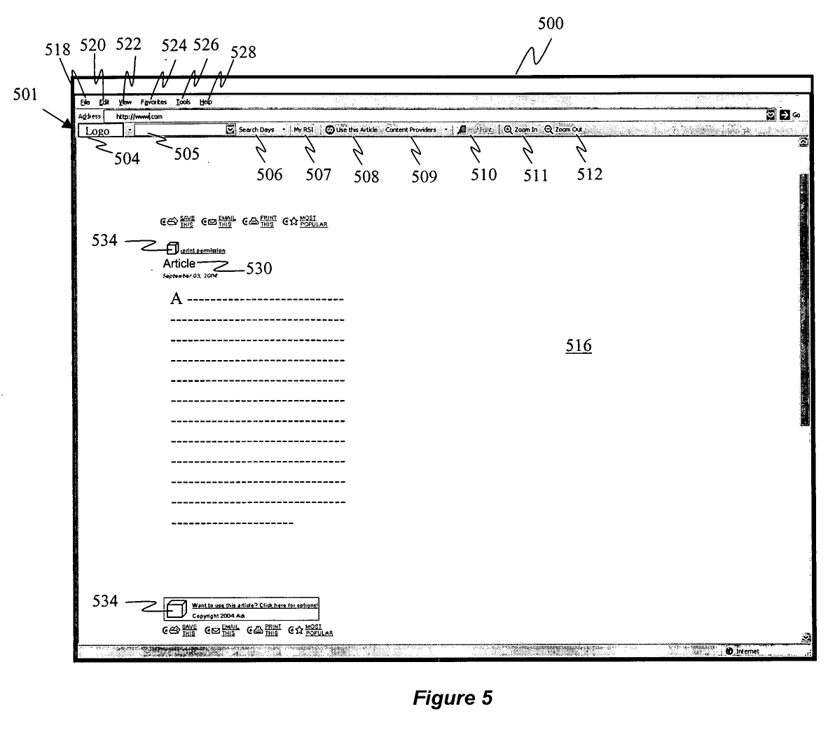

FIG. 5 illustrates one possible embodiment of a graphics user interface (GUI) application 500 including a digital content license toolbar 501. Once the digital content license toolbar 501 is installed on a graphics user interface 500 as discussed above, toolbar menu icons 504-512 are available through inheritance to subsequently launched instances of an application (e.g., INTERNET EXPLORER) and new applications. Similarly, when a configuration of the toolbar 501 changes, the new configuration may take effect in all open application windows and in subsequently launched application windows.

The embodiment of FIG. 5 shows a graphical user interface 500 in a relatively fundamental form, where the application employs, for example, document window 516 within an operating environment having pull down menu categories or icons. The menu categories include, for example, File 518, Edit 520, View 522, Favorites 524, Tools 526 and Help 528 accessible using a pointer, the position of which may be controlled, for example, by a cursor control device as previously described such as a mouse, trackball, or the like. The graphical user interface 500 environment can be driven by an operating system and can include, for example, hardware interfaces to resources such as printers, input devices, output devices, and the like as would be appreciated by one skilled in the art of operating system design.

The document window 516 is configured to display content such as an article 530. The article incorporates links (or tagged fields) 534, such as hyperlinks, to a clearance service for purchasing or licensing the article for reuse. A tagged field is, for example, custom extensible markup language (XML) code that identifies different characteristics of content. For example, a tag can identify the title of an article. In general, the licensing of content provides a user with a limited license to print, reprint, e-mail (distribute) or display the content on the user's intranet. The user can incur additional charges if the licensed material is distributed outside the user's company/intranet, i.e., distributed over the Internet to unlicensed users.

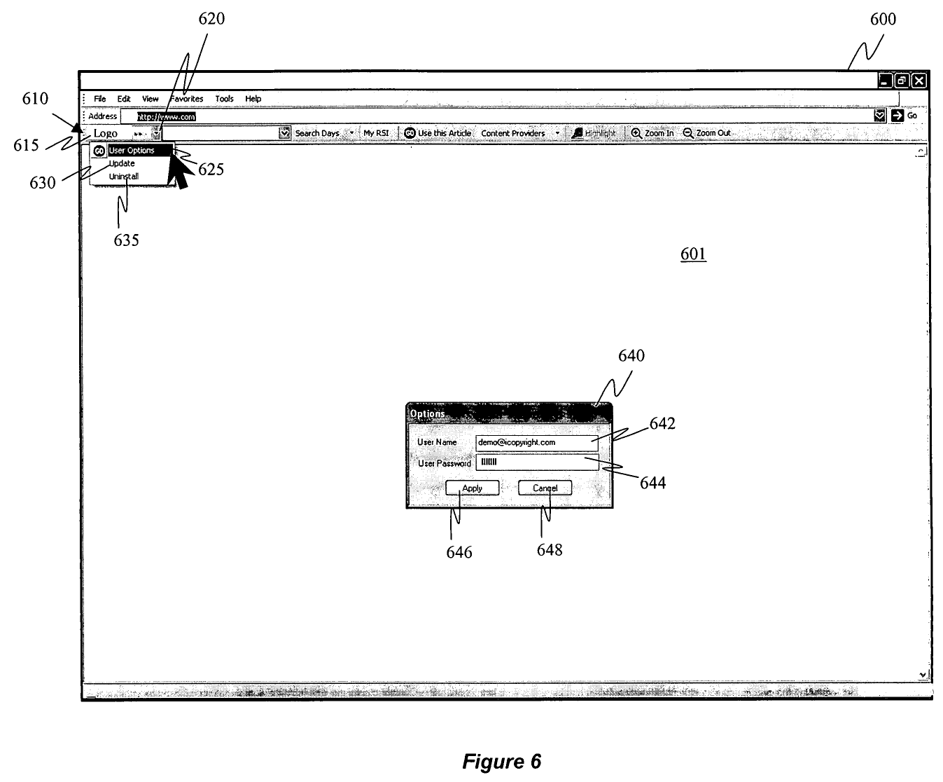

FIG. 6 illustrates a general setup functionality for the digital content license toolbar 610. The toolbar 610 includes several menu items (or icons) as discussed above. The logo menu icon 615, when selected, will take a user (i.e., customer, publisher, author) to the toolbar provider's homepage. The toolbar provider, as used herein, is the provider providing the service to access content owner data. Here, the user can obtain detailed information on, for example, licensing and reprint services.

The user can also select the dropdown menu arrow 620 on the logo icon 615 to display addition menu items. These menu items include a user options function 625, update function 630, and an uninstall function 635. When the user options menu item 625 is selected, a pop-up window 640 is displayed in the document window 601 of the graphical user interface 600. The user is prompted to enter a username 642 and password 644 which will be stored in memory and used to enter the toolbar provider's sites. To complete the operation the user selects the apply button 646, or cancels the operation by selecting the cancel 648 button.

The update function 630 allows the toolbar software to be manually updated to the newest version. Accordingly, by selecting the update function 630, the user is prompted to either continue with an update to the most current version of the toolbar software or cancel the selected operation. Alternatively, the user can set a parameter in the user options 625 to perform the update automatically. Hence, if a new version of the toolbar is subsequently released, the toolbar software is automatically activated to check the installed version and, if different from the released version, update to the most current version. In either the manual or automatic update operation, the user is subsequently notified as to the current version of the software installed.

The uninstall function 635 uninstalls the toolbar and associated software. Accordingly, by selecting the uninstall function 635, the user is prompted to either continue with the uninstall operation or cancel the selected operation. The user is then notified as to the current version of the toolbar.

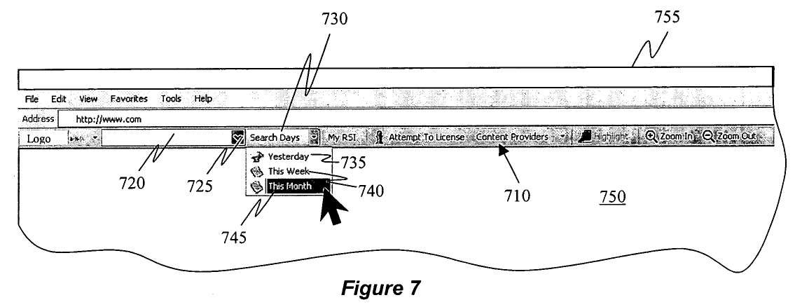

FIG. 7 illustrates the search functionality of the digital content license toolbar 710. A search text field 720 is provided on the toolbar 710. The search text field 720 allows the user to enter search criteria. For example, criteria such as a company name is entered into the search text field 720. Alternatively, the menu arrow 725 can be selected to reveal a search history. The user then highlights the desired query from the search history by using a pointing device such as the arrow keys on the keypad or the mouse. The highlighted criteria are then loaded into the search field 720.

The user then selects a timeframe for which the search is to be conducted. This is accomplished by selecting the search days icon 730 to reveal a dropdown menu of toolbar 710 into the document window 750 of the graphical user interface 755. The dropdown menu provides multiple ranges in which the search is to be conducted. For example, a user can search the previous day 735, the past week 740, or the past month 745. When the range 735, 740, 745 is selected, a search is automatically executed. A summary of search results is discussed in below.

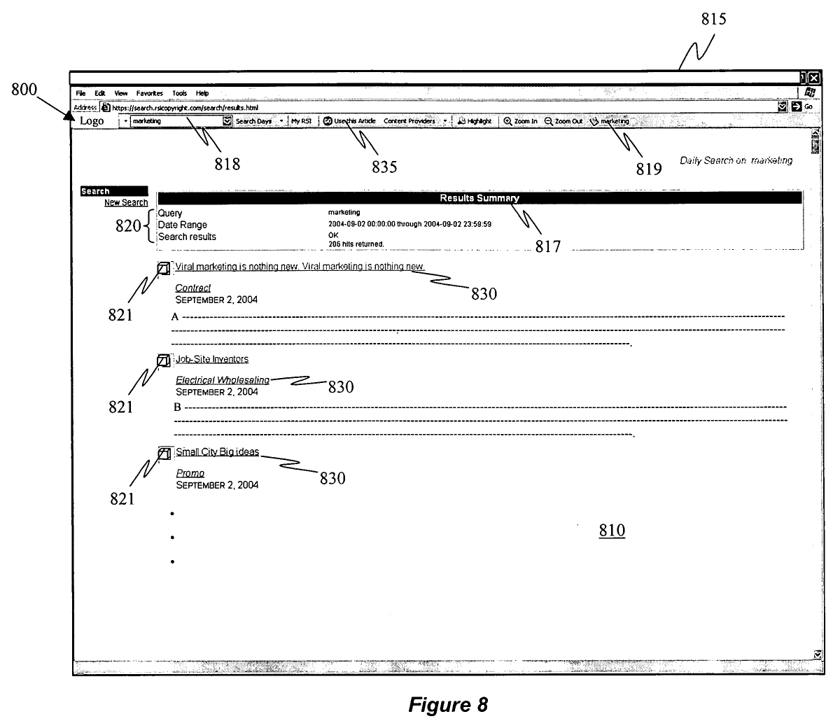

FIG. 8 illustrates a search results summary report generated by the digital content licensing toolbar 800. Search results are displayed, for example, in a paginated format (over multiple pages) in the document window 810 of the graphical user interface 815. This paginated format will provide the user the ability to easily navigate through the results as well as improve the speed of the results that are returned from the search. However, the search results are not limited to a paginated format and any suitable formats can be used. In addition, when bandwidth or memory of the targeted processor is not sufficient, the summary of the search results can be transmitted to and displayed or stored on another server(s).

In operation, when the range 735, 740, 745 is selected (as discussed in FIG. 7), the user will be automatically be logged into one or more search databases/web pages using login information stored within the user's registry. The user is not limited to any specific database and can search, for example, the World Wide Web or any other desired location coupled to the user's computer system.

To gain access to the desired databases/locations, user login information is retrieved from the registry (e.g., https://www.rsicopyright.com/ics/user_reg/user_login.html) and transmitted to login pages of licensed and/or unlicensed sites. The user's registry can be located in any sufficient memory location and populated using information stored by the options menu 625 (FIG. 6). The login pages will accept the login information from the toolbar registry and will authenticate the user. If the login information is valid, the user will automatically be logged into the system and associated search databases/web pages.

A search results summary report 817 lists the content, such as article abstracts, that match the search criteria entered in a search field 818. For example, if the search criteria “marketing” were entered in the search field 818, any content matching this criterion is displayed as, but not limited to, abstracts in the document window 810 of the graphical user interface 815. The search criterion is replicated 819 and displayed on the toolbar 800 and in the summary report along with a timestamp and number of hits returned 820. As mentioned above, this embodiment is not limited to displaying abstracts of the result content and any suitable format is used, for example, the full text of each article can be displayed.

The results summary report 817 includes dynamic license icons 821 that precede each article 830 returned. The dynamic license icons 821 indicate whether the retrieved article 830 is, for example, instantly licensable or not. The license icon 821 dynamically changes to display availability, licensability or no charge for the retrieved content. However, one skilled in the art will realize that other indications, such as visual (e.g., color and text) or audio, can be used. For example, a green license icon indicates that accessed content is licensed by a user's site license, a yellow license icon indicates that the accessed content can be licensed by a user, and a red license icon indicates that the user is restricted from accessing content.

In general, the license icon 821 found in the results summary report 817 will include the following two major functions: notify the user that the content they are viewing is either (1) already covered by the user's license so they can print, e-mail or display the content on their intranet or (2) instantly licensable as indicated by either a changing of the color of the dynamic license icon 821 or by presenting a message to the user.

More particularly, the user typically has several licensing options. These include: (1) the user does not own a site license but the site provides licensable content, in which case the user can login to the site by filling out a request form and then obtain the desired content; (2) the user has an internal site license (e.g., internal to the user's company) to access the content, and thus, the user can only use content for internal (company) needs; and (3) the user has an internal site license to the access content, but would like to use the content for purposes not authorized pursuant to the license agreement. However, these licensing options are not exhaustive and other licensing option can be created as required.

In operation, software associated with the license icon 821 will parse through each page of each retrieved HTML source code document to verify if a tag is embedded within the code. The tag is code, such as metadata or the like, that a content owner, or a subsequent aggregator or distributor or a distribution agent such as the operator of the system described herein, includes in published content, such as a published article transmitted on the World Wide Web (WWW). If the tag does appear within the page, the toolbar will assume that the article can be instantly licensable and will notify the user by, for example, changing the text or color of the license icon 821.

When viewing content that has been identified as being instantly licensable, the user will have the ability to select the license icon 821 and license the content. Upon selecting the license icon 821, the user will be directed (e.g., hyperlinked) to the content provider's site just as if they had selected the link included in the tagging of the article (FIG. 5, 534) or the toolbar license icon 835, which will be discussed in greater detail later. For example, by selecting the license icon 821, the appropriate web page will be displayed (i.e., the content provider's site), in which the user can proceed to license the article. Again, if the user has a valid username and password stored in the registry, the user will automatically be logged-in at the content provider's site to continue the license process.

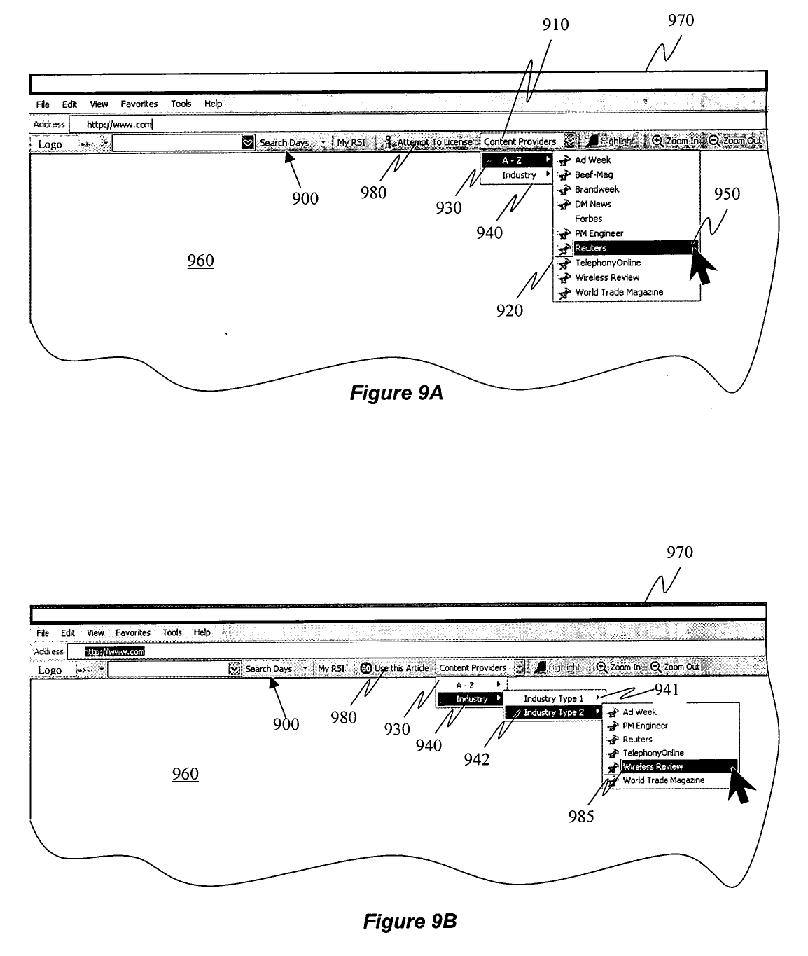

FIG. 9A illustrates a content provider functionality of digital content licensing toolbar 900. A content provider icon 910 is provided on the toolbar 900. By selecting the content provider icon 910, a user can choose from a list of content providers 920. Content providers can be selected from either an alphabetical list 930 or by industry 940. For example, if a content provider, such as REUTERS 950, is selected from the alphabetical list 930, the REUTERS' homepage is displayed in the document window 960 of the graphical user interface 970.

At this point, the user can select an article from the REUTERS homepage. After the article is selected, the toolbar license icon 980 indicates whether the selected article 830 is, for example, instantly licensable or not. If the content is instantly licensable, the license icon 980 will indicate such availability with appropriate text or color message such as “Use This Article.” If the content is not instantly licensable, the license icon 980 will indicate this status with appropriate text or color message such as “Attempt to License.” Hence, the license icon 980 dynamically changes to display availability, licensability or no charge for the retrieved article. However, one skilled in the art will realize that other indications, such as visual (e.g., color), audio or other forms of text, can be used.

In operation, software associated with the toolbar license icon 980 will parse through the selected page of the retrieved HTML source code document (i.e., the selected article) to verify if a tag is embedded within the code. The tag is code, such as metadata or the like, is included by the content owner in the published content, such as a published article transmitted on the World Wide Web (WWW). If a tag appears within the page, the toolbar will assume that the article can be instantly licensable and will notify the user by, for example, changing the color of the license icon 980. However, one skilled in the art will realize that other indications, such as audio or text, can be used. For example, the license icon 980 can dynamically change, displaying a message indicating the licensing status of the selected article.

FIG. 9B illustrates additional content provider functionality of digital content licensing toolbar 900. As discussed above, a content provider can be selected from either an alphabetical list 930 or by industry 940. The industry type can be separated into multiple menu items. In this embodiment industry type is separated into Industry Type 1 (941) and Industry Type 2 (942). If a content provider, such as WIRELESS REVIEW 985 is selected, the WIRELESS REVIEW homepage is displayed in the document window 960 of the graphical user interface 970.

At this point, the user can select an article from the homepage of WIRELESS REVIEW. After the article is selected, the toolbar license icon 980 indicates whether the selected article 985 is, for example, instantly licensable or not. The license icon 980 dynamically changes to display availability, licensability or no charge for the retrieved article. However, one skilled in the art will realize that other indications, such as visual (e.g., color), audio or text, can be used.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

The claimed invention is:

1. A method for displaying search results and identifying licensing status, the method comprising:
performing a query on selected criteria;
listing results of the query in a specified format; and
indicating a licensing status for each result in the listing.

2. The method of claim 1 further comprising determining the licensing status for each result in the listing by parsing each result for a licensing tag.

3. The method of claim 2, wherein determining the licensing status further comprises determining whether each of the results are selected from the group consisting of licensed user content, unlicensed user content and free content.

4. The method of claim 1, wherein listing the results further comprises listing an abstract of each result.

5. The method of claim 1, wherein indicating the licensing status further comprises displaying a different indicator for each licensing status.

6. The method of claim 5, wherein displaying the different indicator for each licensing status further comprises:
displaying a first visual message indicating that a result is instantly licensable; and
displaying a second visual message indicating that a result is not instantly licensable, wherein a request can be made as to how the result can be licensed.

7. The method of claim 5, wherein displaying a different indicator for each licensing status further comprises:
displaying a first audio message indicating that a result is instantly licensable;
displaying a second audio message indicating that a result is not instantly licensable, wherein a request can be made as to how the result can be licensed

8. The method of claim 5, wherein displaying a different indicator for each licensing status further comprises displaying an audible indicator.

9. The method of claim 1, wherein indicating the licensing status further comprises displaying a text message.

10. The method of claim 1, wherein listing the results further comprises listing licensed and unlicensed content.

11. The method of claim 1, wherein performing a query further comprises using registry data to automatically login to one or more queried databases.

12. A computer system for displaying search results and identifying licensing status for each item in the search results, the computer system comprising:
a user interface;
a processor coupled to the user interface for displaying a toolbar on the user interface, the toolbar having a search field for performing a search on selected criteria;
an output device coupled to the processor for listing results of the search in a specified format; and
an indicator linked to each search result in the listing for displaying a licensing status for each of the results in the listing.

13. The computer system of claim 12 further comprising a licensing status application for determining the licensing status for each result in the listing by parsing each result for a licensing tag.

14. The computer system of claim 13, wherein the licensing status is selected from the group consisting of licensed user content, unlicensed user content and free content.

15. The computer system of claim 12, wherein the indicator linked to each search result further comprises a different indicator for each licensing status.

16. The computer system of claim 15, wherein the different indicator for each licensing status further comprises:
a first indicator for displaying a text message indicating that licensable result content is licensed by a user;
a second indicator displaying a text message indicating that licensable result content is not licensed by the user; and
a third indicator displaying a text message indicating no information is available for a result content.

17. The computer system of claim 15, wherein the different indicator for each licensing status further comprises:
a first indicator displaying a first designated color indicting that licensable result content is licensed by a user;
a second indicator displaying a second designated color indicting that licensable result content is not licensed by the user; and
a third indicator displaying a third designated color indicting no information is available for the result content.

18. The computer system of claim 15 further comprising a different audible indicator for each licensing status.

19. The computer system of claim 15 further comprising a different visual indicator for each licensing status.

20. The computer system of claim 12, wherein the indicator linked to each search result comprises a text message.

21. The computer system of claim 12, wherein the toolbar further comprises a registry for providing information for automatically logging into one or more queried databases.

22. A user menu interface for identifying licensing status for each item in a search result, comprising:
a search field for performing a search on selected criteria; and
an indicator displaying a licensing status for a selected result in a listing.

23. The user menu interface of claim 22, wherein the selected result is an abstract.

24. The user menu interface of claim 22, wherein the indicator further comprises a different indicator for each licensing status.

25. The user menu interface of claim 24, wherein the different indicator for each licensing status further comprises:
a first visual indicator indicating that a result is instantly licensable; and
a second visual indicator indicating that a result is not instantly licensable, wherein a request can be made as to how the result can be licensed.

26. The user menu interface of claim 24, wherein the different indicator for each licensing status further comprises:
displaying a first audio indicator indicating that a result is instantly licensable;
displaying a second audio indicator indicating that a result is not instantly licensable, wherein a request can be made as to how the result can be licensed.

27. The user menu interface of claim 22 further comprising an audible indicator for each licensing status.

28. A program storage device readable by a computer tangibly embodying one or more programs of instructions executable by the computer to perform a method for displaying search results and identifying licensing status, the method comprising:
performing a query on selected criteria;
listing results of the query in a specified format; and
indicating a licensing status for each result in the listing.

29. A system for associating tagged content with a licensee, the system comprising:
one or more content owners providing tagged content; and
a user menu interface associated with a specific licensee for displaying license status of tagged content;
wherein the license status displayed is based on the tagged content of the one or more content owners for which the specified licensee has purchased a license.

30. The system of claim 29, wherein the license status displayed further comprises:
a first license status indicating that a result is instantly licensable; and
a second license status indicating that a result is not instantly licensable, wherein a request can be made as to how the result can be licensed.

31. The system of claim 29 further comprising a plurality of licensees simultaneously associated with the one or more content owners, wherein each of the a plurality of licensees have a user menu interface that includes a unique list of content owners for which site licenses have been granted.

32. The system of claim 29 further comprising a plurality of licensees simultaneously associated with the one or more items of content, wherein each of the a plurality of licensees have a user menu interface that includes a unique list of items of content for which site licenses have been granted.
